(19) United States
(12) Patent Application Publication
(10) Pub. No.: US 2012/0128994 A1
(43) Pub. Date: May 24, 2012

(54) PROMOTING UNCURED TACK AND CURED ADHESION FOR TIRE COMPONENT RUBBER COMPOSITIONS INCLUDING A TREAD SPLICE

(76) Inventors: Ramendra Nath Majumdar, Hudson, OH (US); Paul Hary Sandstrom, Cuvahoga Falls, OH (US); Erik Paul Sandstrom, Uniontown, OH (US); Michelle L. Sandstrom, Uniontown, OH (US)

(21) Appl. No.: 13/282,560

(22) Filed: Oct. 27, 2011

Related U.S. Application Data
(60) Provisional application No. 61/416,791, filed on Nov. 24, 2010.

(51) Int. Cl. B32B 25/04

(52) U.S. Cl. 428/448; 428/419; 428/451; 428/497

(57) ABSTRACT

This invention relates to promoting building tack for an uncured rubber composition and promoting cured adhesion between rubber compositions as components for a tire and a tire prepared thereby. The uncured building tack and cured adhesion is observed to be promoted, for example, by application of a composition containing rosin ester or hydrogenated rosin ester and at least one of uncured sulfur curable rubber, sulfur based rubber curative, reinforcing filler, tackifier resin and high boiling organic solvent. In one embodiment, the invention relates to a tire rubber tread splice.

This application claims the benefit of and incorporates by reference U.S. Provisional Application No. 61/416,791, filed Nov. 24, 2010.

### FIELD OF THE INVENTION

This invention relates to promoting building tack for an uncured rubber composition and promoting cured adhesion between rubber compositions as components for a tire and a tire prepared thereby. The uncured building tack and cured adhesion is observed to be promoted, for example, by application of a composition containing rosin ester or hydrogenated rosin ester and at least one of uncured sulfur curable rubber, sulfur based rubber curative, reinforcing filler, tackifier resin and high boiling organic solvent. In one embodiment, the invention relates to a tire rubber tread splice.

### BACKGROUND OF THE INVENTION

Rubber tires are often prepared by building an assembly of uncured, sulfur curable, rubber components. It is important that the surfaces of the uncured rubber components have a degree of building tack so that when the surfaces of the uncured rubber components are pressed together to form a tire assembly, or at least a portion of a tire assembly, they sufficiently adhere together for tire building purposes as is well known to those having skill in such art.

For example, a circumferential uncured, sulfur curable, rubber tread strip might be applied to form a tire assembly, namely an assembly of uncured rubber components, many of which are in contact with each other for which building tack for their interfacial surfaces is important.

In practice, the uncured rubber tread strip might be applied, or wound around, the tire carcass with the ends of the circumferential uncured rubber strip joined in a form of a splice. The ends of the tread strip are generally cut (skived) at an angle, such as for example, about a 20° C. angle (e.g. about a 20° C. angle to the horizontal plane of the uncured tread strip), to thereby promote an increase in the contact area of the joined surfaces of the ends of the uncured strips. Such skiving procedure for tire tread strips is well known to those having skill in such art.

Generally it is desired that the surfaces of the uncured rubber components, such as for example the ends of the tread rubber strip have a degree of tackiness, sometimes referred to as building tack, so that when the uncured rubber components, for example the ends of the tread rubber strip, are pressed together, the composite of rubber compositions, for example the tread splice, holds together and is suitable for subsequent shaping and curing the tire. However, it is sometimes desired to promote an increase in building tack for the surfaces of the uncured rubber components, for example, the ends of the uncured rubber tread strip.

Historically, an organic solvent, or an organic solvent based, rubber-containing, composition, which might sometimes be referred to as a cement, might sometimes be applied, where appropriate, to the one or more surfaces of an uncured rubber component to promote building tack for the uncured rubber surfaces. For example, ends, or faces, of opposing skived surfaces of an uncured tire tread strip may be so-treated to promote building tack.

Examples of various cements for such purpose and joined rubber tread splices, in general, may be referred to in one or more of U.S. Pat. Nos. 3,335,041; 3,421,565; 3,342,238; 3,514,423; 4,463,120 and 4,539,365. It is readily observed that such exemplary cements are typically based on, for example, relatively volatile solvent solutions of compositions comprised of, for example, combination of a base rubber, carbon black, tackifier resin and curative and which may also contain an oil. Further exemplary U.S. Pat. Nos. are 3,335,041, 4,539,365, 4,497,927 and 5,951, 797.

Due to the small adhesion area and large strain potentially applied to a tread splice, tackifying compositions to promote rubber tack for this application are often limited to organic solvent based compositions to tackify the uncured rubber. It is believed that the solvents increase the molecular mobility of the polymers in the adhesive and increase the wetting of the end surfaces of the rubber tread strip at the splice. Apparently the wetting and molecular mobility promote good adhesion to the substrate. Water based adhesives have replaced rubber cements in some less demanding applications due to their lower volatile organic emissions. Elastomeric laminates containing a solventless elastomeric adhesive such as disclosed in U.S. Pat. No. 5,503,940 have been used to adhere treads to a buffed tire carcass.

For this invention it is desired to evaluate various candidates for both promoting building tack for surfaces of uncured rubber compositions and to promote adhesion between opposing surfaces of uncured rubber substrates and, also, to promote adhesive strength for the cured composite of the opposing rubber substrates.

In the description of this invention, the terms “rubber” and “elastomer” if used herein, may be used interchangeably, unless otherwise prescribed. The terms “rubber composition”, “compounded rubber” and “rubber compound”, if used herein, are used interchangeably to refer to “rubber which has been blended or mixed with various ingredients and materials” and such terms are well known to those having skill in the rubber mixing or rubber compounding art.

The term “phr” where used herein, and according to conventional practice, refers to parts of a respective material per 100 parts by weight of rubber, or elastomer.

### SUMMARY OF THE INVENTION

In accordance with this invention a method of promoting building tack for a surface of an uncured, sulfur curable, rubber composition comprises providing a coating thereon of at least one of rosin ester and hydrogenated rosin ester, particularly by providing a coating of at least one of liquid rosin ester and liquid hydrogenated rosin ester, to said uncured rubber surface.

In one embodiment, said coating is a composition comprised of a combination of rosin ester or hydrogenated rosin ester and at least one of uncured sulfur curable rubber, sulfur based rubber curative, reinforcing filler, tackifier resin and high boiling predominately hydrocarbon solvent.

Thus, the rosin ester or hydrogenated rosin ester is applied in a liquid form to the uncured rubber surface. While it is preferred that the rosin ester or hydrogenated rosin ester is liquid at 23° C. (e.g. at about an ambient room temperature) it is to be appreciated that it may have a melting point higher than 23° C., for example up to about 60° C., so that it may be necessary to heat it to liquify it before application as a coating to the uncured rubber surface.

Such rosin may be, for example, at least one of gum rosin, wood rosin and tall oil rosin, all of which are well known rosins.

Historically, rosins are solid resinous materials comprised primarily of rosin acids that occur naturally in pine trees. As indicated above, the three major sources of rosin are gum rosin, wood rosin and tall oil rosin. Gum rosin is generally from the oleoresin extrudate of the living pine tree. Wood rosin is generally from the oleoresin contained in aged tree stumps. Tall oil rosin is from the waste liquor recovered as a by-product in the Kraft paper industry.

As indicated, said rosin ester may be an ester of a hydrogenated rosin (esterified rosin acid of which the rosin is primarily composed) and referred to herein as a hydrogenated rosin ester in a sense that a hydrogenated rosin is esterified.

A further description of such rosins, as well as some rosin esters, may be found, for example, in U.S. Pat. No. 5,504,127, “Monoesters of Rosin Acid” which is referenced herein in its entirety.

Such rosins may be esterified, for example, by reaction with a saturated aliphatic alcohol, (used for the rosin esterification) preferably a low molecular weight aliphatic alcohol, representative of which are, for example, methyl alcohol, ethyl alcohol, isopropyl alcohol and n-propyl alcohol, particularly methyl alcohol.

Alternately, as indicated, a tack promoting composition for the surface of an uncured, sulfur curable rubber composition may be provided which is comprised of:

(A) at least one of:
(1) uncured, sulfur curable, diene-based elastomer (e.g. exclusive of isobutylene based rubber such as for example butyl rubber and halogenated butyl rubber),
(2) sulfur curative for said diene-based elastomer comprised of sulfur and at least one sulfur vulcanization accelerator,
(3) reinforcing filler comprised of at least one of rubber reinforcing carbon black and precipitated silica,
(4) tackifier resin (other than rosin ester or hydrogenated rosin ester),
(5) solvent, predominantly hydrocarbon solvent, having a boiling point of at least 180° C., and

(B) at least one of rosin ester and hydrogenated rosin ester (which may act as a solvent for the tack promoting composition).

It is to be appreciated that said tack promoting composition which contains an uncured, sulfur curable, diene-based rubber may desirably not contain a sulfur curative therefore and more simply rely upon sulfur curative contained in the rubber substrate on which it is coated for interfacial sulfur curing of the coating.

In one embodiment, in order to provide a liquid coating to the surface of said uncured rubber surface, said rosin ester, or hydrogenated rosin ester, based composition may include up to 30, for example from about 5 to about 20, weight percent of a solvent having a boiling point of at least 180° C. to reduce its viscosity, if desired. Such solvent is predominately hydrocarbon (predominantly carbon and hydrogen atoms) and therefore basically inert in a sense of being principally chemically inert to said rosin ester and hydrogenated rosin ester. Solvents having boiling points below 180° C. are therefore to be excluded.

In one embodiment, such method includes applying a coating of said liquid rosin ester, hydrogenated rosin ester, or said tack promoting composition thereof, which may alternately contain a solvent having a boiling point of least 180° C. to reduce its viscosity, to one or both opposing ends of an uncured, sulfur curable, tread rubber strip and adhering the opposing ends of said uncured tread rubber strip together with said coating therebetween.

In practice, as indicated, said sulfur curative may be provided as a curative package comprised of sulfur and at least one sulfur vulcanization accelerator.

Representative of a hydrogenated methyl ester of wood rosin is, for example, Hercoln® D from Pinova, Inc.

Methyl esters of rosins, including hydrogenated methyl esters of rosins may be desirable because they may have a relatively low viscosity at room temperature, or 23° C. and therefore may be easier to apply, as a liquid, to the uncured rubber substrate.

The composition for this invention is desirably free of petroleum oil (petroleum derived oil) and free of organic solvent having a boiling point lower than about 180° C., and also free of water.

Such composition varies from and is a departure from volatile solvent based contact adhesives for adhering spliced ends of an uncured rubber tread strip together in one sense that it does not contain volatile organic solvents and, in particular, organic solvents having a boiling point of less than 180° C.

In further accordance with this invention, a composite comprised of an uncured, sulfur curable rubber composition is provided having a tack promoting coating on at least one surface thereof comprised of said liquid rosin ester, hydrogenated rosin ester or said tack promoting composition thereof.

In additional accordance with this invention, a tire is provided where said tire is comprised of an assembly of uncured sulfur curable rubber components wherein at least one of said rubber components is said composite.

In further accordance with this invention, two of said rubber components are adjoining rubber components (rubber components which adjoin each other) and wherein at least one of said adjoining rubber components is comprised of said composite of uncured rubber and said tack promoting coating thereon wherein said tack promoting coating is positioned between said adjoining rubber components.

In further accordance with this invention, said tire assembly of uncured rubber components is provided wherein one of said components is an uncured circumferential rubber tread strip with opposing ends of said rubber tread strip adhered together with said tack promoting rosin ester, hydrogenated rosin ester, or said tack promoting composition thereof therebetween.

In one embodiment, said tire assembly is sulfur cured to form a tire.

It is undertaken herein to evaluate candidates to promote building tack for surfaces of uncured rubber compositions together promoting bonding strength between two co-vulcanized rubber compositions which do not contain volatile organic solvents (solvents having a boiling point below 180° C.) and do not contain petroleum based oil.

In one embodiment, the candidate is applied to at least one of, and optionally both of, opposing uncured surfaces of an uncured rubber composition(s), such as, for example ends of an uncured rubber tread strip and their opposing surfaces then adhered together to form a composite thereof and the composite co-cured to form an integral cured composite thereof with the candidate therebetween.

In practice, the candidate may be comprised of, for example, a liquid rosin ester or hydrogenated rosin ester, or a composition comprised of, for example, based on parts per weight per 100 parts by weight rosin ester or hydrogenated rosin ester (phr) of at least one of:

(A) up to about 15 phr of at least one uncured, sulfur curable, rubber including cis 1,4-polyisoprene natural rubber and/or at least one diene based rubber, preferably comprised of least one of synthetic cis 1,4-polyisoprene rubber and cis 1,4-polybutadiene rubber and styrene/butadiene copolymer rubber;

(B) curative for said rubber composed of sulfur and alternately at least one sulfur cure accelerator (e.g. up to about 1 phr of sulfur);

(C) up to about 10 phr of reinforcing filler comprised of at least one of rubber reinforcing carbon black and precipitated silica with a silica coupler for said precipitated silica;

(D) up to about 3 phr of tackifier resin (rubber tackifying resin such as, for example, tackifier resin comprised of, for example, phenol formaldehyde or phenol acetylene based tackifier resins), and

(E) solvent (e.g. predominately hydrocarbon solvent) having a boiling point of at least 180° C. (e.g. up to about 30 phr, alternately from about 5 to about 20, phr thereof).

As indicated, if desired, particularly where a lower viscosity composition (candidate) is desired, the candidate may contain up to 30 phr of organic solvent having a boiling point of at least 180° C.

As heretofore indicated, the candidate is free of organic solvents having boiling points below 180° C. As indicated, the candidate is also free of water.

In one embodiment, an important aspect of the invention is that the candidate can contain an uncured sulfur vulcanizable rubber.

In one aspect, it is desirable for the candidate to have a green tack (adhesion) value, greater than about 2, preferably greater than about 4, Newtons (N) per a one inch (2.54 cm) wide test area.

Where a solvent might be used to prepare the candidate, selection of the solvent is not considered as being a critical feature of the invention so long as it is predominantly hydrocarbon and has a boiling point of greater than 180° C.

In the practice of this invention, it is understood that, where appropriate, suitable rubber compounding ingredients can be added to the composition, if desired, including one or more of antidegradants, pigments, zinc oxide, stearic acid, zinc stearate and cure accelerators.

It is to be appreciated that the preparation of the tire assembly of components, application or building of the tread onto the tire and the vulcanizing, or curing, of the assembly in a suitable mold under conditions of pressure and elevated temperature are well known to those having skill in such art.

The following examples are provided which are intended to be illustrative in nature and the parts and percentages by weight unless otherwise indicated.

### EXAMPLE I

Candidates were evaluated, as reported in Tables 1 and 2, for both their suitability of providing building tack for joining two uncured rubber compositions comprised of emulsion polymerization prepared styrene/butadiene rubber (E-SBR) and cis 1,4-polybutadiene rubber in a weight ratio of about 70/30, and, also, providing cured adhesive strength for the two joined and co-cured rubber compositions, namely providing a sulfur co-cured composite of two rubber compositions with a thin layer of the Candidate composition therebetween.

The first column in Tables 1 and 2 reports original and aged tack and adhesion where no surface treatment is used where it can be seen that original and aged tack were very poor which points out a need for improving the tack.

Candidate A was a Control Candidate composition for comparison purposes as a solvent based adhesive comprised of a volatile organic solvent such as, for example, n-heptane, uncured sulfur curable rubber, carbon black and sulfur curative comprised of sulfur and sulfur cure accelerator.

Candidate B was comprised of rosin oil, not a rosin ester.

Candidate C was a liquid rosin ester. It can be mentioned that a petroleum oil has previously been evaluated as a coating but did not add any appreciable tack to the surface of the uncured rubber substrate.

Candidate D was a composition comprised of a liquid hydrogenated wood rosin methyl ester (methyl ester of hydrogenated wood rosin), and the remainder of ingredients of Candidate

A except that the volatile organic solvent was not used.

Uncured rubber substrates were provided comprised of sulfur curable conjugated diene-based elastomers, namely the E-SBR and cis 1,4-polybutadiene, rubber reinforcing carbon black, fatty acid, zinc oxide, sulfur and sulfur cure accelerator(s).

Two of the uncured, sulfur curable, rubber substrates were pressed together with a thin Candidate composition therebetween with tack results shown in Table 1. Another composite thereof was prepared and cured at an elevated temperature and the cured adhesion results also shown in Table 1.

For the evaluation reported in Table 1, a protective polyethylene film was removed from the surfaces of the respective uncured rubber substrates to create a fresh uncured rubber surface.

For aged evaluation reported in Table 2, a protective polyethylene film was removed from the surfaces of the respective uncured rubber substrates and the uncovered rubber surfaces exposed to the atmosphere (thereby exposed to atmospheric conditions) for 7 days to allow various ingredients within the rubber to migrate to the rubber surfaces for the rubber surface to become aged.

The tack and adhesion was measured by a force displacement test apparatus with results shown in the following Tables.

| | | | | |
|---|---|---|---|---|
| | | | Experimental | |
| | Control | | C | D |
| | A | | Liquid | Liquid |
| | Volatile | | Hydrogenated | Hydrogenated |
| No Surface | Solvent | B | Rosin Ester | Rosin Ester |
| Treatment | Cpsn | Rosin Oil | w/Tackifier | Cpsn |

Table 1-Uncured Tack and Cured Adhesion

| | | | | | |
|---|---|---|---|---|---|
| Uncured surface tack¹ Newtons/cm | 0.03 | 3.1 | 0.07 to 1.0 | 0.63 | 7+ |
| Acceptable | No | Yes | No | No | Yes |
| Cured adhesion² Newtons/cm | 458+ | 469+ | 0 | 152 | 122+ |
| Acceptable | Yes | Yes | No | Yes | Yes |

Table 2-Aged Tack and Cured Adhesion

| | | | | | |
|---|---|---|---|---|---|
| Uncured surface tack¹ Newtons/cm | 0.035 | 3.8 | N/A | 0.56 | 3.2 |
| Acceptable | No | Yes | N/A | No | Yes |
| Cured adhesion² Newtons/cm | 122 | 134 | N/A | 304+ | 189+ |
| Acceptable | Yes | Yes | N/A | Yes | Yes |
| Acceptable for BOTH fresh and | No | Yes | No | No | Yes |
| aged tack and cured adhesion | | | | | |

N/A means “Not Applicable”
Cpsn means “Composition”

Observations from Tables 1 and 2 Above

For an acceptable uncured original and aged tack values, where an acceptable tack value for the purposes of this invention is at least 1.6 Newtons/cm, only Control A (volatile solvent cpsn) and Candidate D (liquid hydrogenated rosin ester cpsn) were acceptable for both unaged and aged tack values for which it was hoped, and was observed, that Candidate D would as least be equivalent to Candidate A.

For an acceptable cured and aged cured adhesion values, where an acceptable adhesion value for the purposes of this invention is at least 70 Newtons/cm, Candidates A, C and D were acceptable and Candidate B was not acceptable in terms of cured adhesion.

In conclusion, only Candidate D (liquid hydrogenated rosin ester cpsn) provided all of acceptable initial uncured tack and aged tack for the uncured rubber composition, in combination with acceptable cured adhesion values as a replacement for Candidate A, a volatile solvent (boiling point of less than 180° C., namely n-heptane) based composition.

It is observed that Candidate B, composed of rosin oil, gave negligible uncured tack and cured adhesion values and was therefore considered as being unacceptable.

Candidate C, which is mostly liquid hydrogenated rosin ester, can be seen in Table 1 enhanced both fresh (original) and aged tack values of the rubber surface by more than 10 fold. For this specific rubber composition, even with such tack enhancement did not reach an acceptable level. However, it is to be appreciated that for a different rubber composition the rubber surface tack might become an acceptable tack value.

### ¹Uncured Tack Measurements

The tack measurements were measured with a force displacement analytical equipment. The tack determination measures the interfacial tack of two green, or uncured, samples of a rubber composition after having been compressed together with an applied force.

### The Tack Test

In general, uncured rubber compound is calendered and test samples are built from two uncured 3″×6″ (7.6×15.2 cm) rubber samples with masking tape applied to one side and a polyethylene sheet is applied to the other side.

For original tack values the polyethylene sheet is removed to expose a fresh surface.

For aged tack values, the polyethylene sheet is removed and the surface allowed to age, namely be exposed to atmospheric conditions, for a period of time, namely 7 days.

For tack determination, two test pieces are pressed together, with a thin layer of candidate positioned therebetween, by an automated apparatus for 30 seconds at 25° C.±2° C. at 0.21 MPa (2 atmospheres) of pressure. The calendered sample is then cut with a specimen die so that five samples each having a longitudinal width of one inch (2.54 cm) ready to be pulled apart on a force displacement tester or equivalent with pneumatic jaws, such as is available from Instron.

The sample (composite) is removed from the press and several specimen samples cut from the pressed sample.

The rubber layers were pulled apart to measure the tack between the layers at about 25° C. with a force displacement apparatus at a cross head speed of about 12.7 cm/min.

### ²Cured Adhesion Measurements

Cured adhesion is measured similar to the aforesaid tack test except that the composite was cured at about 28 minutes at about 23° C. under a pressure of about 0.671 MPa and the adhesion measured at about 95° C.

### EXAMPLE II

A Candidate was evaluated for both its suitability of providing building tack for joining two uncured rubber compositions comprised of natural rubber based rubber compositions, and, also, providing cured adhesive strength for the two joined and co-cured rubber compositions, namely providing a sulfur co-cured composite of two rubber compositions with a thin layer of the Candidate composition therebetween.

Rubber Sample E was a Control rubber Sample composition for comparison purposes without its surface having been treated with Candidate, therefore without surface treatment.

Candidate F was Candidate D of Example I comprised of the liquid hydrogenated wood rosin methyl ester composition (cpsn) and the remainder of ingredients for Candidate A of Example I, except that the volatile organic solvent was not used, although it did contain a minimal amount of about 5 phr of predominantly hydrocarbon based solvent having a boiling point greater than 180° C. to reduce the viscosity of the composition, namely Hydrosol® from Total Petrochemicals, Inc. which is indicated as being a mineral oil.

Uncured rubber substrates comprised of the aforesaid sulfur curable natural rubber based rubber composition, rubber reinforcing carbon black, fatty acid, zinc oxide, sulfur and sulfur cure accelerator(s) were prepared.

Two of the uncured, sulfur curable, rubber substrates were pressed together with a thin Candidate composition therebetween with tack results shown in Table 3. Another composite thereof was prepared and cured at an elevated temperature and the cured adhesion results also shown in Table 3.

For the evaluation reported in Table 3, a protective polyethylene film was removed from the surfaces of the respective uncured rubber substrates to create a fresh uncured rubber surface.

For aged evaluation reported in Table 4, a protective polyethylene film was removed from the surfaces of the respective uncured rubber substrates and the uncovered rubber surfaces exposed to the atmosphere (thereby exposed to atmospheric conditions) for 7 days to allow the rubber surfaces to become aged.

The tack and adhesion was measured by the force displacement test apparatus with results shown in the following Tables.

| | |
|---|---|
| No Surface | |
| Treatment | Candidate |
| E | F |

Table 3-Uncured Tack and Cured Adhesion

| | | |
|---|---|---|
| Uncured surface tack¹ Newtons/cm | 3.63 | 21.94 |
| Acceptable | Yes | Yes |
| Cured adhesion² Newtons/cm | 667 | 695 |
| Acceptable | Yes | Yes |

Table 4-Aged Tack and Cured Adhesion

| | | |
|---|---|---|
| Uncured aged surface tack¹ Newtons/cm | 1.08 | 2.62 |
| Acceptable | No | Yes |
| Cured aged adhesion² Newtons/cm | 480 | 249 |
| Acceptable | Yes | Yes |
| Acceptable for BOTH fresh and aged tack | No | Yes |
| and cured adhesion | | |

Observations from Tables 3 and 4 Above

For an acceptable uncured original and aged tack values, where an acceptable tack value for the uncured rubber composition for the purposes of this invention is at least 1.6 Newtons/cm, rubber Sample E (untreated rubber sample) was observed to be acceptable for both unaged and unacceptable for aged tack values. Both aged and fresh (unaged) tack values for the surface of the rubber composition become acceptable when the rubber surface was treated with the Candidate F which was based on the hydrogenated rosin ester.

For an acceptable cured and aged cured adhesion values, where an acceptable adhesion value for the purposes of this invention is at least 70 Newtons/cm, both rubber Sample E and the rubber sample with its surface treated with Candidate F were acceptable, for which it was hoped, and was observed, that Candidate F would successfully be at least equivalent to untreated rubber Sample E.

While various embodiments are disclosed herein for practicing the invention, it will be apparent to those skilled in this art that various changes and modifications may be made therein without departing from the spirit or scope of the invention.

What is claimed is:

1. A method of promoting building tack for a surface of an uncured, sulfur curable, rubber composition comprises providing a coating of at least one of liquid rosin ester and liquid hydrogenated rosin ester to said uncured rubber surface, wherein said liquid rosin ester and liquid hydrogenated rosin ester are liquid at a temperature of less than about 60° C.

2. The method of claim 1 wherein said liquid rosin ester is a hydrogenated rosin ester.

3. The method of claim 1 wherein said coating is a composition comprised of combination of rosin ester of hydrogenated rosin ester and at least one of uncured sulfur curable rubber, sulfur based rubber curative, reinforcing filler, tackifier resin and high boiling solvent having a boiling point greater than 180° C.

4. The method of claim 1 wherein the rosin for said liquid rosin ester and liquid hydrogenated rosin ester is comprised of at least one of gum rosin, wood rosin and tall oil rosin; wherein said liquid rosin ester and hydrogenated rosin ester is a reaction product of rosin or hydrogenated rosin with a saturated aliphatic alcohol so long as said rosin ester and hydrogenated rosin ester are liquid at a temperature of less than about 60° C.

5. The method of claim 4 wherein said saturated aliphatic alcohol is comprised of at least one of methyl alcohol, ethyl alcohol, isopropyl alcohol, and n-propyl alcohol.

6. A composite comprised of an uncured, sulfur curable rubber composition having a tack promoting coating on at least one surface thereof comprised of at least one of liquid rosin ester and hydrogenated rosin ester.

7. The composite of claim 6 wherein said liquid rosin ester is a hydrogenated rosin ester.

8. The composite of claim 6 wherein said tack promoting composition is comprised of:
(A) at least one of:
(1) uncured, sulfur curable, diene-based elastomer;
(2) sulfur curative for said diene-based elastomer comprised of sulfur and optionally at least one sulfur vulcanization accelerator,
(3) reinforcing filler comprised of at least one of rubber reinforcing carbon black and precipitated silica,
(4) tackifier resin,
(5) solvent having a boiling point of at least 180° C., and
(B) at least one of rosin ester and hydrogenated rosin ester.

9. The composite claim 6 wherein said liquid rosin ester and hydrogenated rosin ester is a reaction product of rosin or hydrogenated rosin with saturated aliphatic alcohol so long as said rosin ester and hydrogenated rosin ester are liquid at a temperature of less than about 60° C.

10. The composite of claim 6 wherein said saturated aliphatic alcohol is comprised of at least one of methyl alcohol, ethyl alcohol, isopropyl alcohol, and n-propyl alcohol.

11. The composite of claim 6 sulfur cured.

12. The composite of claim 8 sulfur cured.

13. A tire comprised of an assembly of uncured sulfur curable rubber components wherein at least one of said rubber components is comprised of the composite of claim 6.

14. A tire comprised of an assembly of uncured sulfur curable rubber components wherein at least one of said rubber components is comprised of the composite of claim 8.

15. A tire comprised of an assembly of uncured sulfur curable rubber components wherein at least two of said rubber components are adjoining composites comprised of the composite of claim 6 with said tack promoting composition therebetween.

16. A tire comprised of an assembly of uncured sulfur curable rubber components wherein at least two of said rubber components are adjoining composites comprised of the composite of claim 8 with said tack promoting composition therebetween.

17. The tire of claim 13 sulfur cured.

18. The tire of claim 14 sulfur cured.

19. The tire of claim 15 sulfur cured.

20. The tire of claim 16 sulfur cured.
